(19) United States
(12) Patent Application Publication
(10) Pub. No.: US 2005/0258147 A1
(43) Pub. Date: Nov. 24, 2005

(54) Guide block and method for embodying divisions on a slide plane of a guide block

(76) Inventor: Steven Donders, Pfeghofstrasse (DE)

Correspondence Address: SCULLY, SCOTT, MURPHY & PRESSER;400 GARDEN CITY PLAZA, GARDEN CITY, NY, 11530, US

(21) Appl. No.: 10/522,863

(22) PCT Filed: Aug. 5, 2003
(86) PCT No.: PCT/EP03/08650

§ 371 Date: Jan. 31, 2005

(30) Foreign Application Priority Data
Aug. 5, 2002 (DE) 102 35 813.3

(51) Int. Cl. B23K 15/00; F16C 33/10; B23K 26/20; B23K 10/02

(52) U.S. Cl. 219/121.14; 219/121.64; 219/121.46

(57) ABSTRACT

The invention relates to a guide block and a method for embodying divisions on a slide plane (22) of a guide block blank (47). The divisions (25) are applied to the guide block blank (47), then a base surface (26) for the slide plane (22) on the guide block blank (47) is pre-prepared. After introduction of a material (41) for application to the base surface (26), a local fusion of the introduced material (41) is carried out, by means of a non-contact heat input (35). Particular forms for the divisions (25) are generated by means of moving the guide block blank (47) and/or a beam (35) of the heat input (34) relative to each other. Finally the support surfaces of the molten material (41) are levelled to generate a planar support surface for the slide plane (22).

The invention relates to a guide block and a method for embodying divisions on a slide plane of a guide block.

To generate the stroke movement of pistons in hydrostatic piston machines, the pistons are supported on a slide face, for example an inclined disc or swash-plate (hereinafter swash-plate), by means of a guide block. The swash-plate is connected non-rotatably to the housing of the piston machine. This produces relative motion between the guide blocks and the swash-plate. Because the guide blocks are subjected to high mechanical loads, they must be made of a material having sufficient mechanical strength. However, materials of high mechanical strength generally have a high coefficient of friction in their interaction with the swash-plate.

From DE 196 01 721 A1 it is known to reduce this friction between the slide face of the swash-plate and the slide face of the guide block by inserting a slide part in the slide face of the guide block. The slide part is made of a material which ensures sufficient residual slidability on the swash-plate even when lubrication is absent. In addition, a plurality of divisions are arranged on the guide block slide face, by means of which a cushion of pressure medium is built up, so that the guide block runs on a hydrostatic sliding bearing during operation of the hydrostatic piston machine. For this purpose the divisions form on the guide block slide face a kind of labyrinth which ensures a uniform cushion of pressure medium, which is supplied through a pressurised-oil bore. Through this hydrostatic relief the wear induced by friction is significantly reduced.

A disadvantage of the guide block known from DE 196 01 721 A1 is that a plurality of processing operations requiring machining processes are necessary. Apart from the high expenditure of material, the processing times are significantly increased thereby. In addition, burrs produced during machining can cause increased wear when the piston machine is put into operation.

It is the object of the invention to provide a method for embodying divisions and a corresponding guide block whereby less material is used and a short processing time is required.

This object is achieved by the method according to the invention comprising the process steps according to claim 1, and by the guide block according to the invention as claimed in claimed 18.

With the method according to the invention it is advantageous to permanently join the material from which the divisions are to be produced to a guide block blank by means of a non-contact process. The join is produced by means of a heat input. Through the heat input the previously supplied material is fused and thereby permanently fixed to the guide block blank in the form of a soldered or welded joint.

Through the non-contact input of heat a complex geometry of the divisions can be produced even using simple means. Unlike the case with machined divisions, the limits of the possible geometries are not set by the dimensions of the cutting tool or its feed rate. The small diameter of a laser beam or an electron beam, for example, also makes possible especially small radii. In addition, it is possible to integrate the inventive method for applying the divisions into the production process of the guide block. The high logistical complexity and cost entailed by machining, and by the multi-part construction of guide blocks hitherto, are eliminated. Not only the direct production cost but also storage costs are thereby reduced.

Through the measures specified in the dependent claims, advantageous refinements of the method according to the invention are possible.

In particular, it is advantageous to supply the material to be applied in the form of powder, which is then fused to the guide block blank, e.g. by means of a laser beam. According to a further refinement of the invention, the surplus material is blown from the guide block blank after the divisions have been formed. The material recovered in this way can optionally be fed back into the manufacturing process.

A further advantage is that, without a tool change, not only can the slide face of the guide block be provided with divisions, but an oppositely-oriented annular face, on which sliding friction between the guide block and a return plate occurs, can also be provided.

Through the use of a process in which a non-contact heat input takes place the entire heat input into the workpiece is kept low, since conduction of heat through the material is not required. It is thereby also possible to apply material to edge portions of the guide block without distortion of the material taking place. Furthermore, heat treatment of the guide block blank to achieve greater material strength is not nullified by a major input of heat.

In addition, the supply of the material by means of a winding device has the advantage that after the end of the process the residual material is wound back on to a spool or reel and a cleaning process of the processing station is not required. Moreover, the spool or reel containing the used material can optionally be fed back to a recycling process.

The method according to the invention is elucidated in more detail in the following description and is represented in the drawings, in which:

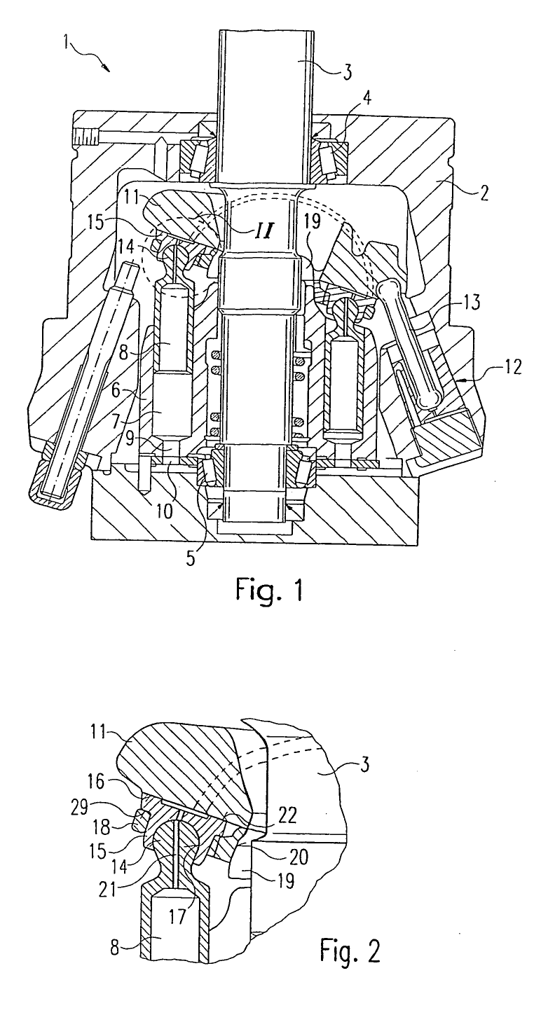

FIG. 1 is a schematic representation of an axial piston machine;

FIG. 2 is an enlarged representation of section II of FIG. 1;

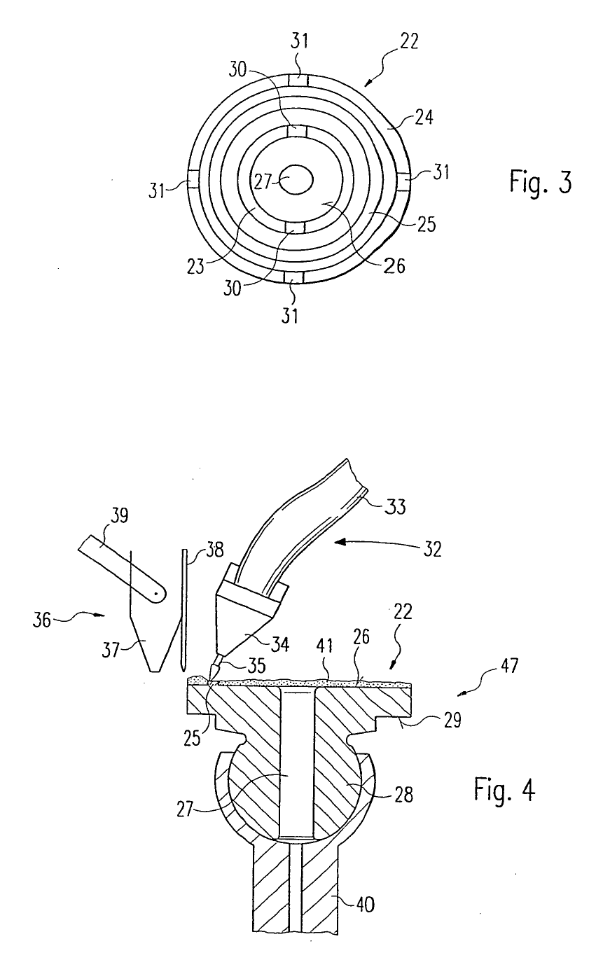

FIG. 3 is a view of a guide block slide face having a plurality of divisions;

FIG. 4 is a schematic representation of a first example of the method according to the invention;

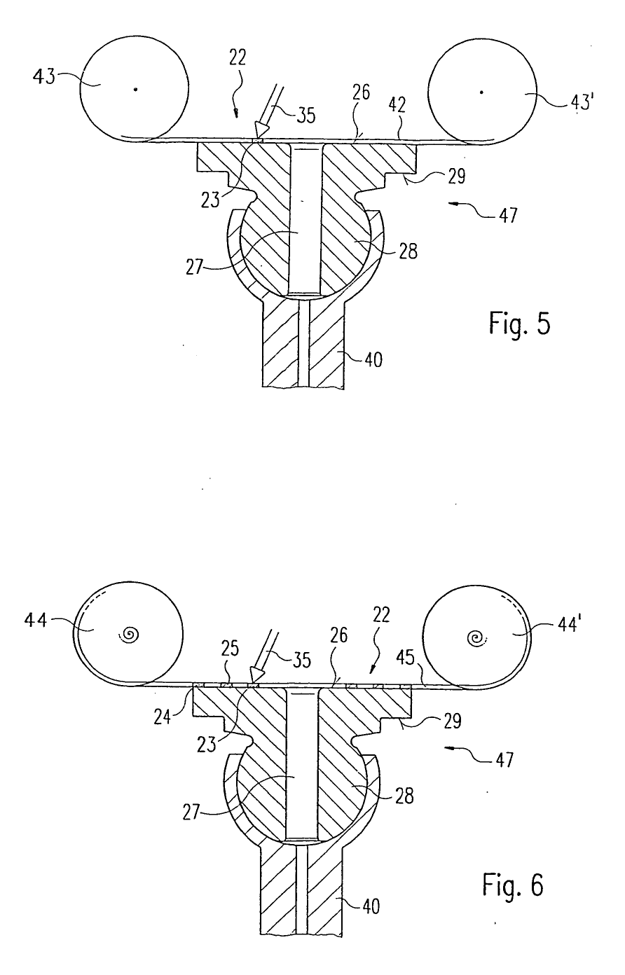

FIG. 5 is a schematic representation of a second example of the method according to the invention;

FIG. 6 is a schematic representation of a third example of the method according to the invention;

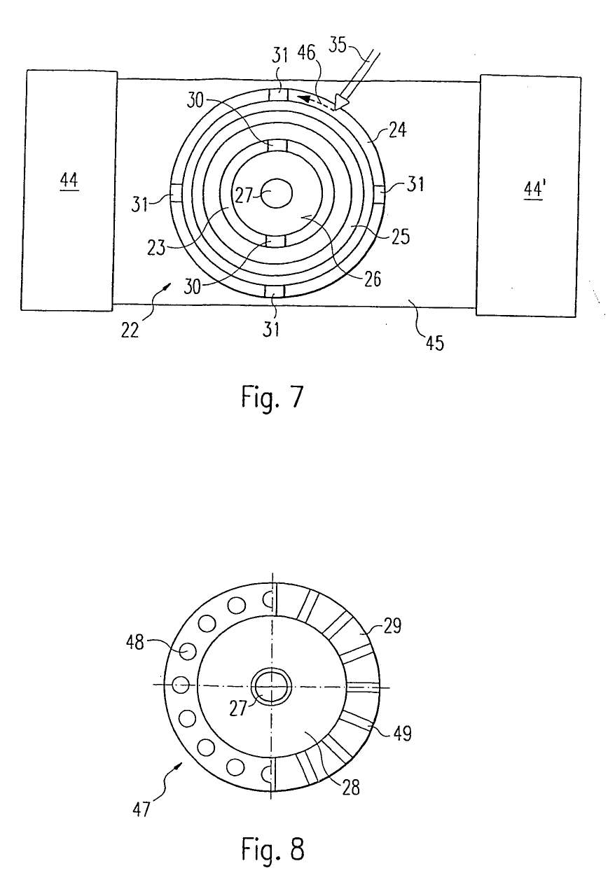

FIG. 7 is a schematic representation of the third example of the method according to the invention from a second perspective;

FIG. 8 is a schematic representation of two geometries for divisions on an annular face of the guide block; and

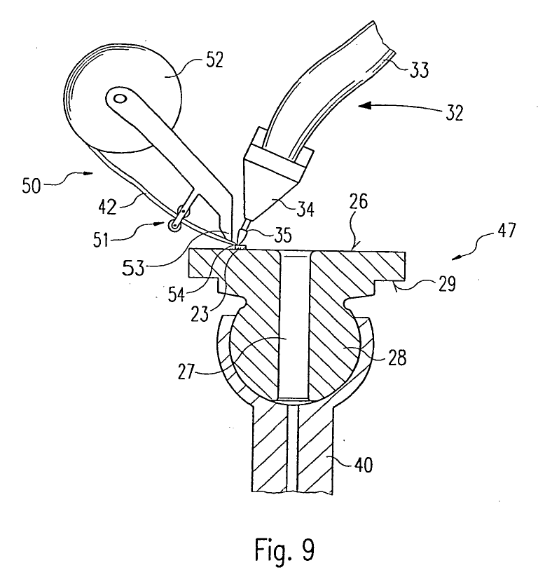

FIG. 9 is a schematic representation of a fourth example of the method according to the invention.

For a better understanding of the invention the construction of the essential components of an axial piston machine 1 will first be explained with reference to FIG. 1. The axial piston machine 1 has a housing 2 inside which a shaft 3 is journalled. A bearing 4 and a further bearing 5 arranged at the opposite end of the shaft 3 are used for journalling the shaft. A cylinder drum 6 is connected non-rotatably to the shaft 3. A plurality of cylinder bores 7 are incorporated in the cylinder drum 6 and are distributed uniformly around its perimeter. The cylinder bores 7 serve to accommodate pistons 8. The pistons 8 are arranged to be longitudinally displaceable in the cylinder bores 7.

When a stroke movement is executed, in the case when the axial piston machine is operated as a hydraulic pump, pressure medium is forced out of the cylinder bores 7 through cylinder ports 9 into a control chamber 10 during a compression stroke. The control chamber 10 is connected to a working line in a manner not shown. A swash-plate 11 is used to generate the stroke movement of the pistons 8. The angle of the swash-plate 11 relative to the shaft 3 is adjustable by means of an adjusting device 12, an appropriate force being applied to an adjusting piston 13 of the swash-plate 11 and thus adjusting same.

The pistons 8 have on their ends facing away from the cylinder port 9 a spherical head 14. The spherical head 14 is connected to a guide block 15 which bears against the swash-plate 11. The interaction between the swash-plate 11, the pistons 8 and the guide blocks 15 will be elucidated in detail with reference to the enlarged section in FIG. 2.

The guide block 15 bears on a slide face 16 of the swash-plate 11, the guide block 15 sliding over the slide face 16 along a circular path when the cylinder drum 6 is rotated. During a compression stroke, because of the pressure prevailing in the cylinder bore 7, the guide block 15 is maintained in contact with the swash-plate 11, so that a slide face 22 of the guide block 15 is in abutment with the slide face 16 of the swash-plate 11. In order to ensure that the guide block 15 also remains in contact with the swash-plate 11 during a suction stroke, a return plate 18 is provided. During the suction stroke the return plate 18 retains the guide block 15 through abutment on an annular face 29 which is oriented in the opposite direction to the slide face 22. To ensure a constant distance of the return plate 18 from the slide face 16 of the swash-plate 11, the return plate 18 bears against a thrust bearing 19.

The thrust bearing 19 has a cup-like external contour on which the return plate 18 slides during an adjustment movement of the swash-plate 11, so that it can follow the adjustment movement by rotation. Through the forming of a spherical head 14 on the piston 8 and a corresponding spherical recess 17 in the guide block 15, both traction and compression forces can be transmitted between the pistons 8. To reduce the friction between the spherical head 14 and the spherical recess 17, a lubricating oil bore 21 is provided, through which the contact face between the guide block 15 and the spherical head 14 is supplied with lubricant from the cylinder bore 7. Also provided in the guide block 15 is a through-bore which conveys the pressure medium to the slide face 22 of the guide block 15.

A plan view of a guide block slide face 22 is illustrated in FIG. 3. The slide face 22 has a base surface 26 on which a plurality of divisions are arranged. The divisions are in the form of circular lands, bearing lands being distinguished from sealing lands.

As was explained above in the discussion of FIG. 2, a through-bore 27 through which pressure medium is forced in the direction of the slide face 22 during the compression stroke is provided in the guide blocks 15. The pressure medium emerging from the through-bore 27 is first distributed as far as a first bearing land 23 which is formed as an elevation on the base surface 26. The first bearing land 23 has a circular configuration and has two oil apertures 30, said two oil apertures 30 being formed diametrically as recesses in the first bearing land 23. The pressure medium emerging via the oil apertures 30 is prevented from escaping rapidly in a radial direction by a sealing land 25 which is also formed as an elevation on the base surface 26. Unlike the first bearing land 23, the sealing land 25 has no oil apertures.

In the embodiment illustrated in FIG. 3 the first bearing land 23, the sealing land 25 and a second bearing land 24 are arranged concentrically to one another. The diameters of the first bearing land 23, of the sealing land 25 and of the second bearing land 24 increase continuously. Further oil apertures 31 are formed in the second bearing land 24. The slide face 22 illustrated has a total of four oil apertures 31 in the second bearing land 24, distributed uniformly around the circumference of the second bearing land 24.

While a material of high mechanical strength is used for the guide block blank, the divisions are made from a material which ensures sufficient residual slidability on the slide face 16 of the swash-plate 11 even when lubrication is absent. For this purpose, the divisions may be made, for example, from the materials high-strength brass or bronze which are known as bearing materials. However, through the method according to the invention, which is described in detail below, other materials, preferably plastics or ceramics but also non-ferrous metals, may be applied to the base surface 26 of the guide block blank.

The method according to the invention for forming the divisions will now be described with reference to the schematic representation in FIG. 4. A guide block blank 47 is fed to a processing station and clamped into a holder 40. Instead of the guide block 15 described above which has a spherical recess 17 which is connected to a spherical head 14 of the piston 8, the articulated joint of the guide blocks described below is so configured that the guide block blank 47 concerned has a spherical guide block head 28 which cooperates with a corresponding recess in the piston 8 to form an articulated joint.

The method described below can be used on both slide planes of the guide block blank 47, i.e. those on the guide block slide face 22 and on the annular face 29. The following exposition is restricted first of all to the processing of the slide face 22. Before the divisions can be formed on the slide face 22, the base surface 26 of the guide block blank 47 must be so prepared that a face having defined surface quality is produced on which welding or soldering is possible. This can be done, for example, when the guide block blank 47 is machine-turned during its manufacture, or in a separate work step, for example, by grinding.

The material to be applied is now supplied to the base surface 26 pre-finished in this way. In the case of a material to be supplied in powder form a feed device 36 shown in FIG. 4 is used for this purpose. The feed device 36 consists of a nozzle 37 and a scraper 38, the nozzle 37 and the scraper 38 being so connected to one another that they can be moved using a common arm 39. The feed device 36 is now moved across the plane of the slide face 22, the powdery material emerging simultaneously through the nozzle 37. In the drawing the movement takes place from right to left. A part of the powder applied to the base surface 26 in this way is removed by means of the scraper 38 so that a powder layer 41 which has a constant thickness is produced.

The forming of the divisions solidly connected to the base surface 26 is then carried out by local heating of the powder layer 41. For this purpose a laser, for example, is used which is connected to an optical system 34 by means of an optical fibre cable 33, the optical system 34 being movable by means of a guide arrangement, e.g. a robot (not shown). The optical system 34 emits a laser beam 35 so that the powder layer 41 is locally heated by means of the laser beam 35. The local heating of the powder layer 41 leads to the forming of a melt which forms a join with the base surface 26 is it cools.

In relation to the example of the slide face 22 from FIG. 3, the optical system 34 is moved relative to the guide block blank 47 along a plurality of circular paths, so that the pattern of divisions shown in FIG. 3 is produced. To form the oil apertures 30 and 31 it is sufficient if the power of the laser is briefly switched off or sharply reduced at the corresponding sites.

The powder which is not heated during this fusion process is removed from the base surface 26 of the guide block blank 47 by means of a blower (not shown). The blown material is captured and can be fed back to the process. The divisions which have now been formed on the base surface 26 of the guide block blank 47 are levelled in a further processing step. Through the levelling, which may be effected, for example, by a cutting process or by grinding, a defined rough depth with the slide face 16 of the swash-plate 11 is produced on the abutment faces of the first and second bearing lands 23 and 24 and of the sealing land 25.

An alternative means of supplying the material to be applied is represented in FIG. 5. Instead of a powder, a wire 42 is used. The wire 42 is supplied by means of a winding device, the winding device consisting of a first spool 43 and a second spool 43′. The wire 42 is stretched freely between the first spool 43 and the second spool 43′, this free length of wire being held directly above the base surface 26 of the guide block blank 47. During the switched-on period of the laser, the wire 42 is tensioned at all times by winding the wire 42 off the first spool 43 and simultaneously onto the second spool 43′.

By means of the laser beam 35 only a part of the wire 42 is melted in each case. This can be achieved, for example, in that the diameter of the wire exceeds the focus diameter of the laser beam 35. It is also possible to use a wire 42 having a core with a higher melting point, so that only the material surrounding the core is fused. When a wire 42 and a winding device are used, it is advantageous if the optical system is rigidly connected to the winding device, so that the relative positions of the wire 42 and of the laser beam 35 to one another are constant. In addition, through the constant orientation of the laser beam 35 with respect to the fusion site, high process reliability is achieved. In this case the geometries of the divisions are produced by moving the holder 40 together with the guide block blank 47.

FIG. 6 shows a similar arrangement to that in FIG. 5.

Instead of the spools 43 and 43′, a first reel 44 and a second reel 44′ are used for the winding device, by means of which reels 44, 44′ a strip material, for example, a metal foil 45, is positioned in immediate proximity to the base surface 26. FIG. 6 shows a later time in the process, when the second bearing land 24 and the sealing land 25 have already been formed. The laser beam 35 is in the process of producing the first bearing land 23. Through the use of metal foils 45 of different thicknesses, the height of the divisions can be adjusted. If the metal foil 45 is a narrow strip which is only slightly wider than the focus of the laser beam 35, it is advantageous again to couple the winding device and the optical system rigidly to one another and to generate the geometries of the divisions by moving the holder 40 relative thereto.

A further possibility is represented in FIG. 7. The metal film 45 is wider than the longest extension of the divisions, i.e., wider than the diameter of the second bearing land 24 in the example illustrated. It is thereby possible to dispense with the actuation of the winding device during fusion. The metal foils 45 and the holder 40 are not moved during the process. Only the optical system is moved along the divisions to be applied, e.g. by a guide robot, as is indicated by the arrow 46.

Once the divisions have been completely applied to the slide face 22, a new guide block blank 47 is clamped into the holder 40 and the winding device is actuated, so that an unused section of the metal foil 45 is brought into overlap with a new base surface 26 of a guide block blank 47.

Instead of an endless-strip metal foil, the metal foil may, of course, be used individually for each guide block to be manufactured and applied to the guide block in the form of a platelet.

FIG. 8 shows different divisions which can be formed on the annular face 29 of the guide block blank 47 using the method according to the invention. The divisions may be approximately circular faces 48, as shown in the left-hand half of FIG. 8. The circular faces 48 have a diameter which is smaller than the width of the annular face 29.

An alternative configuration is represented in the right-hand half of FIG. 8. Instead of the circular faces 48, straight lands 49 are shown here, the straight lands 49 being formed, for example, in a radial direction. The lands 49 extend over the full width of the annular face 29 and are also distributed uniformly around the perimeter of the annular face 29.

According to the embodiment illustrated in FIG. 9, a further feed device 50 is provided, by means of which the wire 42 is fed directly into the laser beam 35 or into its immediate environment. The further feed device 50 has an advancing device 51 which unwinds the wire 42 from a wire spool 52. The advancing device 51 may consist, for example, of two rollers between which the wire 42 is advanced and at least one of which is driven, as illustrated in FIG. 9. The wire 42 fed in this way is guided by a guide device 53 to a position at which the wire 42 is to be fused to the base surface 26. By means of such an arrangement, firstly, changing of a guide block blank 47 is simplified because of the greater freedom of movement and, secondly, the wire material supplied can be completely fused to the base surface 26, so that no excess material is produced after fusion. The further feed device 50 may also be retained on a common holder with the optical system 34, so that the relative position between the laser beam 35 and an end 54 of the wire 42 to be fused is constant during the process.

The forming of the divisions described above solely with reference to the use of a laser beam 35 can also be carried out using other non-contact methods in which a local heat input takes place. In particular, a plasma beam or an electron beam should be mentioned here as examples.

1. A method for applying divisions to a slide plane of a glide block blank, comprising the following process steps:
prior fabrication of a base surface of the slide plane of the guide block blank;
supply of a material to be applied to the base surface;
local fusion of the material supplied by means of a local non-contact heat input;
production of specific geometries of the divisions by moving the guide block blank and/or a beam of the heat input relative to one another; and
leveling of the abutment face of the fused material to produce a flat abutment face of the slide plane.

2. The method for forming divisions according to claim 1, wherein the heat input takes place in a non-contact manner by means of a laser beam.

3. The method for forming divisions according to claim 1, wherein the heat input takes place in a non-contact manner by means of an electron beam.

4. The method for forming divisions according to claim 1, wherein the heat input takes place in a non-contact manner by means of a plasma beam.

5. The method for forming divisions according to claim 1, wherein the material to be applied is supplied as a powder.

6. The method for forming divisions according to claim 5, wherein the excess powder after fusion is blown or poured off.

7. The method for forming divisions according to claim 1, wherein the material to be applied is supplied as wire.

8. The method for forming divisions according to claim 7, wherein for supplying the wire a feed device which feeds a free end of the wire to the area of the heat input is provided.

9. The method for forming divisions according to claim 7, wherein a winding device is provided for supplying the wire and a part of the wire material is fused on in the area of the free length of wire stretched by the winding device.

10. The method for forming divisions according to claim 1, wherein the material to be applied is supplied as strip.

11. The method for forming divisions according to claim 10, wherein a winding device is provided for feeding the strip and a part of the strip material is fused on in the area of the free length of strip stretched by the winding device.

12. The method for forming divisions according to claim 11, wherein the width of the strip material is greater than the maximum extension of the divisions to be formed.

13. The method for forming divisions according to, claim 1 wherein the divisions are formed on a slide face of the guide block blank.

14. The method for forming divisions according to, claim 1 wherein the divisions are formed on an annular face of the guide block blank oriented oppositely to a slide face.

15. The method for forming divisions according to, claim 1 wherein the material to be applied is a plastics material.

16. The method for forming divisions according to, claim 1 wherein the material to be applied is a non-ferrous metal.

17. The method for forming divisions according to, claim 1 wherein the material to be applied is a ceramic material.

18. A guide block of a hydrostatic piston machine, the guide block having at least one slide plane on which divisions are arranged as elevations, wherein the divisions are formed by local fusion of a supplied material generated by means of a non-contact heat input.
